(19) United States
(12) Patent Application Publication
(10) Pub. No.: US 2018/0068449 A1
(43) Pub. Date: Mar. 8, 2018

(54) SENSOR FUSION SYSTEMS AND METHODS FOR EYE-TRACKING APPLICATIONS

(71) Applicant: VALVE CORPORATION, Bellevue, WA (US)

(72) Inventors: Yasser Malaika, Bellevue, WA (US); Dan Newell, Bellevue, WA (US)

(73) Assignee: VALVE CORPORATION, Bellevue, WA (US)

(21) Appl. No.: 15/258,551

(22) Filed: Sep. 7, 2016

(51) Int. Cl. G06T 7/00; G06F 3/01; G06K 9/00; G06T 7/20; H04N 5/33

(52) U.S. Cl. CPC G06T 7/0044; G06F 3/013; G06K 9/00604; G06T 2207/30201; G06T 7/2066; H04N 5/33; G06T 2207/10048; G06T 7/208

(57) ABSTRACT

Eye-tracking systems and methods for use in consumer-class virtual reality (VR)/augmented reality (AR) applications, among other uses, are described. Certain embodiments combine optical eye tracking that uses camera-based pupil and corneal reflection detection with optical flow hardware running at a higher frequency. This combination provides the accuracy that can be attained with the former and at the same time adds the desirable precision and latency characteristics of the latter, resulting in a higher performing overall system at a relatively reduced cost. By augmenting a camera tracker with an array of optical flow sensors pointed at different targets on the visual field, one can perform sensor fusion to improve precision. Since the camera image provides an overall picture of eye position, that information can be used to cull occluded optical flow sensors, thus mitigating drift and errors due to blinking and other similar phenomena.

### BACKGROUND OF THE DISCLOSURE

### 1. Field of the Disclosure

The disclosure relates generally to computerized image processing, and more particularly to systems and methods for implementing sensor fusion techniques in computerized eye-tracking applications such as in head-mounted displays for virtual reality and/or augmented reality systems with improved features and characteristics.

### 2. General Background

One current generation of virtual reality (“VR”) experiences is created using head-mounted displays (“HMDs”), which can be tethered to a stationary computer (such as a personal computer (“PC”), laptop, or game console), combined and/or integrated with a smart phone and/or its associated display, or self-contained. VR experiences generally aim to be immersive and disconnect the users' senses from their surroundings.

Generally, HMDs are display devices, worn on the head of a user, that have a small display device in front of one (monocular HMD) or each eye (binocular HMD).

A binocular HMD has the potential to display a different image to each eye. This capability is used to display stereoscopic images.

The term “eye tracking” refers to the process of measuring either the point of gaze (i.e., where a person is looking), what the person is looking at, or the motion or position of a person's eye relative to that person's head. Various computerized eye tracking technologies have been implemented in HMDs and other applications, as ordinarily skilled artisans will readily recognize.

Eye trackers measure rotations of the eye in one of several ways. One broad category of eye tracking technology uses non-contact, optical methods for measuring eye location or gaze angle. For example, in one known class of optical eye tracking technology, light, typically in the infrared region, is reflected from the eye and sensed by a video camera. The information sensed by the video camera is then analyzed to extract gaze direction or location of pupil from changes in reflections. Video-based eye trackers sometimes use the corneal reflection or the center of the pupil as features to track over time.

In the context of HMD implementations, a camera-based eye tracking system may include a back-facing camera attached to the housing of the HMD and pointing a user's eye(s) (directly or indirectly) as a means to detect a user's eye position(s). The digital data generated by the camera is transmitted via wired or wireless means to an external device such as a computer (or alternatively, to computer resources located on the HMD itself) for processing and analysis. Computer software in such systems executes eye-tracking algorithms known to ordinarily skilled artisans to detect position of one or both of the user's eyes.

Certain HMD's that include eye-tracking capabilities contain either one or two small displays with lenses and semi-transparent (i.e., “hot”) mirrors embedded in many form factors, such as helmet, eyeglasses (also known as data glasses) or visor. The display units are typically miniaturized and may include CRT, LCD, Liquid crystal on silicon (LCos), or OLED technologies. Hot mirrors provide one possible design approach for eye tracking, and permit the camera or other eye-tracking sensors to get a good view of the eye being tracked. Certain hot mirrors reflect infrared (“IR”) radiation and are transparent to visible light. The hot mirror in certain eye-tracking HMD applications is tilted in front of the eye and allows the IR camera or other eye-tracking sensor to obtain a reflected image of the eye while the eye has a transparent view onto the display screen.

Such optical eye tracking methods are widely used for gaze tracking. Such trackers in certain implementations may require relatively high-resolution cameras capturing at a high frame rate with image processing and pattern recognizing devices to track the reflected light or known ocular structures such as the iris or the pupil. In order to be non-invasive and keep costs down, consumer-grade eye tracking solutions currently known in the art have substantial limitations in terms of performance that prevent the system from being capable of knowing precisely or with low latency the location of the subject's pupil and gaze direction to take full advantage in the case of foveated rendering, and costly high-resolution high-frame-rate cameras may provide only limited benefits.

However, certain currently commercially available and relatively inexpensive camera image-based eye trackers for HMD applications are difficult to run at high frequency and with sufficiently low latency, and they may produce results that are noisy and prone to occlusion in certain implementations. Although such systems may not necessarily be noisy because of low resolution or low frame rate, they may not sample at a sufficiently high rate to characterize the actual movement of the eye because they miss activity that takes place between samples or incorrectly determine beginning or end to saccades (rapid eye movements, discussed further below) and thus generate bad velocity and acceleration data causing error in predictions.

To begin to use prediction and also avoid missing saccades which would cause error in the results, which are important for VR, such systems must typically operate at least at a 240 Hz rate, due to the relatively high speed with which the human eye is known to move or change direction, especially with respect to what is known as saccadic motion. Saccadic motion refers to the unnoticed and sometimes involuntary motion of a person's eyes as they move between planes of focus.

Generally, saccades can be voluntary or involuntary. When a person redirects his or her gaze to look at something, that is a voluntary saccade. A person's eye is constantly performing involuntary micro-saccades which are virtually imperceptible. Micro-saccades can help to refresh the image and edges a person is viewing on the person's retina. If an image does not move on the retina, the rods/cones on the person's retina may become desensitized to the image and the person effectively becomes blind to it.

To detect and measure micro-saccades in an eye-tracking system generally requires a minimum sampling rate of 240 Hz. It is also not generally possible to determine eye motion precisely unless measurements can be performed well enough to decide whether gaze change is a micro-saccade and the gaze is already reverting back onto the object of focus, or whether the eye is instead accelerating away with a voluntary saccade. To improve performance, more frequent and accurate data is required.

Thus, currently available VR camera-based eye-tracking solutions typically do not perform with enough responsiveness, accuracy, or robustness to realize all the potential value of eye tracking for use in a consumer class HMD device. This is because increasing the frame rate and/or resolution of the eye-tracking camera is complex and expensive. Even if possible, such improvements typically generate more data, which increase bandwidth and thus make transmission more difficult and cause additional central processing unit (“CPU”) and/or graphics processing unit (“GPU”) load to calculate gaze direction. The extra load can either increase system cost or take limited computing time away from the application that is rendering on the display.

Another limitation is related to extreme eye angles, which may force the pupil or corneal reflections to go out of view of the camera in certain camera-based eye-tracking systems.

Eye-tracking solutions supplemented by relatively inexpensive and readily commercially available optical flow sensors are a possible improvement to camera-based systems. Generally, optical flow is the pattern of apparent motion of objects, surfaces, and edges in a visual scene caused by the relative motion between an observer (an eye or a camera) and the scene. An optical flow sensor is a vision sensor capable of measuring optical flow or visual motion and outputting a measurement based on optical flow.

Optical flow sensors generally generate data pertaining to relative motion, as opposed to systems that provide data pertaining to relative position. The relative motion data may contain slight errors which over time cause drift as the errors accumulate. There are errors with relative position data as well, but they do not generally drift over time.

Various configurations of optical flow sensors exist. One configuration includes an image sensor chip connected to a processor programmed to run an optical flow algorithm. Another configuration uses a vision chip, which is an integrated circuit having both the image sensor and the processor on the same die, allowing for a compact implementation. An example of this is the type of sensor used extensively in computer optical mice.

Optical flow sensors are inexpensive, very precise, and can operate at a 1 kHz rate or higher. However, they typically exhibit low positional accuracy due to their known propensity to drift over time. So while they can provide good relative information on how far a mouse has traveled over a surface over short intervals of time, they cannot tell where the mouse is on the surface or where it is relative to its starting position because small errors accumulate causing large discrepancies. Combined with their low resolution and inability to “see” an entire user's eye or determine at any point where the eye is gazing, they cannot by themselves typically provide a sufficiently accurate position of the eye.

It is desirable to address the current limitations in this art.

### BRIEF DESCRIPTION OF THE DRAWINGS

By way of example, reference will now be made to the accompanying drawings, which are not to scale.

FIG. 1 is an exemplary diagram of a computing device that may be used to implement aspects of certain embodiments of the present invention.

FIGS. 2A-2D are exemplary diagrams depicting aspects of eye-tracking system configurations for HMD applications that may be used to implement aspects of certain embodiments of the present invention.

FIG. 3 is an exemplary diagram of eye-tracking system designs for HMD applications that may be used to implement aspects of certain embodiments of the present invention.

FIG. 4 is an exemplary flow diagram eye-tracking methods for HMD applications that may be used to implement aspects of certain embodiments of the present invention.

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Reference will now be made in detail to specific implementations of the present invention as illustrated in the accompanying drawings. The same reference numbers will be used throughout the drawings and the following description to refer to the same or like parts.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

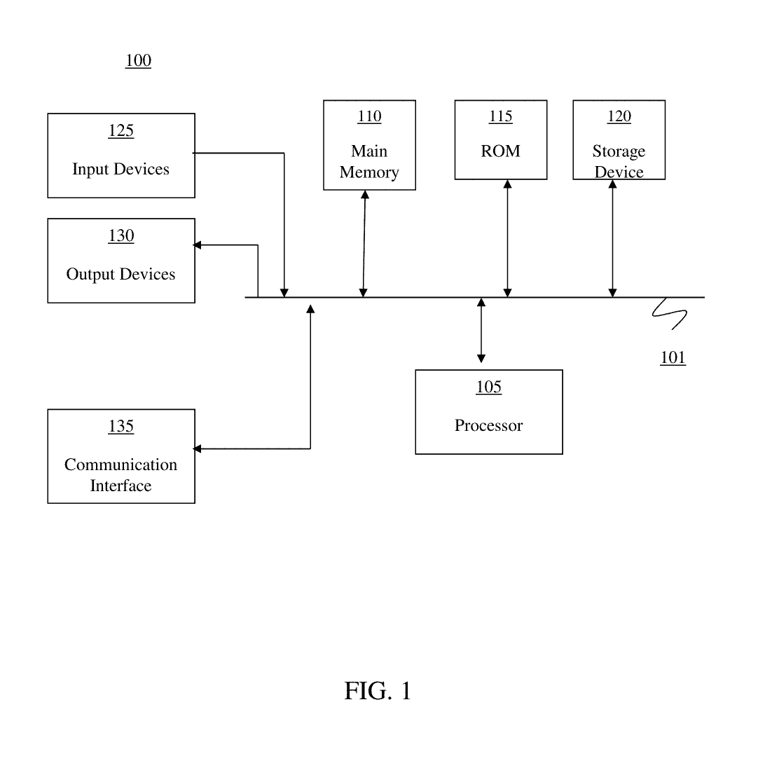

FIG. 1 is an exemplary diagram of a computing device 100 that may be used to implement aspects of certain embodiments of the present invention. Computing device 100 may include a bus 101, one or more processors 105, a main memory 110, a read-only memory (ROM) 115, a storage device 120, one or more input devices 125, one or more output devices 130, and a communication interface 135. Bus 101 may include one or more conductors that permit communication among the components of computing device 100. Processor 105 may include any type of conventional processor, microprocessor, or processing logic that interprets and executes instructions. Main memory 110 may include a random-access memory (RAM) or another type of dynamic storage device that stores information and instructions for execution by processor 105. ROM 115 may include a conventional ROM device or another type of static storage device that stores static information and instructions for use by processor 105. Storage device 120 may include a magnetic and/or optical recording medium and its corresponding drive. Input device(s) 125 may include one or more conventional mechanisms that permit a user to input information to computing device 100, such as a keyboard, a mouse, a pen, a stylus, handwriting recognition, voice recognition, biometric mechanisms, and the like. Output device(s) 130 may include one or more conventional mechanisms that output information to the user, including a display. Communication interface 135 may include any transceiver-like mechanism that enables computing device/server 100 to communicate with other devices and/or systems. Computing device 100 may perform operations based on software instructions that may be read into memory 110 from another computer-readable medium, such as data storage device 120, or from another device via communication interface 135. The software instructions contained in memory 110 cause processor 105 to perform processes that will be described later. Alternatively, hardwired circuitry may be used in place of or in combination with software instructions to implement processes consistent with the present invention. Thus, various implementations are not limited to any specific combination of hardware circuitry and software.

In certain embodiments, memory 110 may include without limitation high-speed random access memory, such as DRAM, SRAM, DDR RAM or other random access solid state memory devices; and may include without limitation non-volatile memory, such as one or more magnetic disk storage devices, optical disk storage devices, flash memory devices, or other non-volatile solid state storage devices. Memory 110 may optionally include one or more storage devices remotely located from the processor(s) 105. Memory 110, or one or more of the storage devices (e.g., one or more non-volatile storage devices) in memory 110, may include a computer readable storage medium. In certain embodiments, memory 110 or the computer readable storage medium of memory 110 may store one or more of the following programs, modules and data structures: an operating system that includes procedures for handling various basic system services and for performing hardware dependent tasks; a network communication module that is used for connecting computing device 110 to other computers via the one or more communication network interfaces and one or more communication networks, such as the Internet, other wide area networks, local area networks, metropolitan area networks, and so on; a client application that may permit a user to interact with computing device 100.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory such as devices based on flash memory (such as solid-state drives, or SSDs). Volatile media include dynamic random access memory (DRAM) and/or static random access memory (SRAM). Transmission media include cables, wires, and fibers, including the wires that comprise a system bus coupled to processor. Common forms of machine-readable media include, for example and without limitation, a floppy disk, a flexible disk, a hard disk, a magnetic tape, any other magnetic medium, a CD-ROM, a DVD, or any other optical medium.

Without limitation, head-mounted-displays (“HMD”) that may be used to implement aspects of certain embodiments of the present invention may be tethered to a stationary computer (such as a personal computer (“PC”), laptop, or game console), or alternatively may be self-contained (i.e., with some or all sensory inputs, controllers/computers, and outputs all housed in a single head-mounted device).

Aspects of the present invention in certain embodiments combine optical eye tracking that uses camera-based pupil and corneal reflection detection with optical flow hardware running at a higher frequency. This combination provides the accuracy that can be attained with the former and at the same time adds the desirable precision and latency characteristics of the latter during the periods between the camera-based samples, resulting in a higher performing overall system at a relatively reduced cost.

By augmenting a camera tracker with one or more optical flow sensors pointed at different targets on the visual field (e.g., different points on the surface of a user's eye, such as the iris or the sclera), one can perform sensor fusion to improve precision. By the same token, since the camera image provides an overall picture of eye position, that information can be used to cull occluded optical flow sensors, thus mitigating drift and errors due to blinking, eyelashes, and other structures or phenomena that interfere with the eye-tracking process.

Thus, adding optical flow sensors, which are relatively inexpensive due to their use in commodity mouse peripherals, helps to fill in the gaps temporally with a higher frequency input. They may also should extend tracking into periods where the camera-based tracking is not providing data, because of occlusion from the eyelid for example, and aid in providing redundant data source to improve the quality and validity of the camera-based data

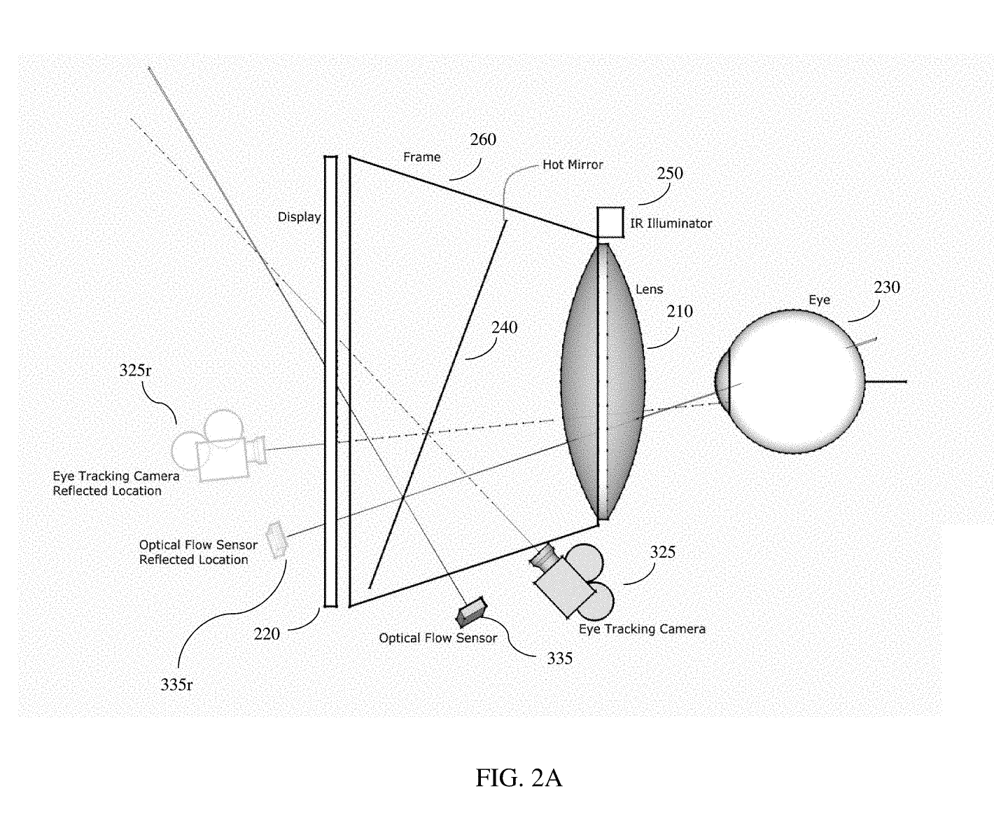

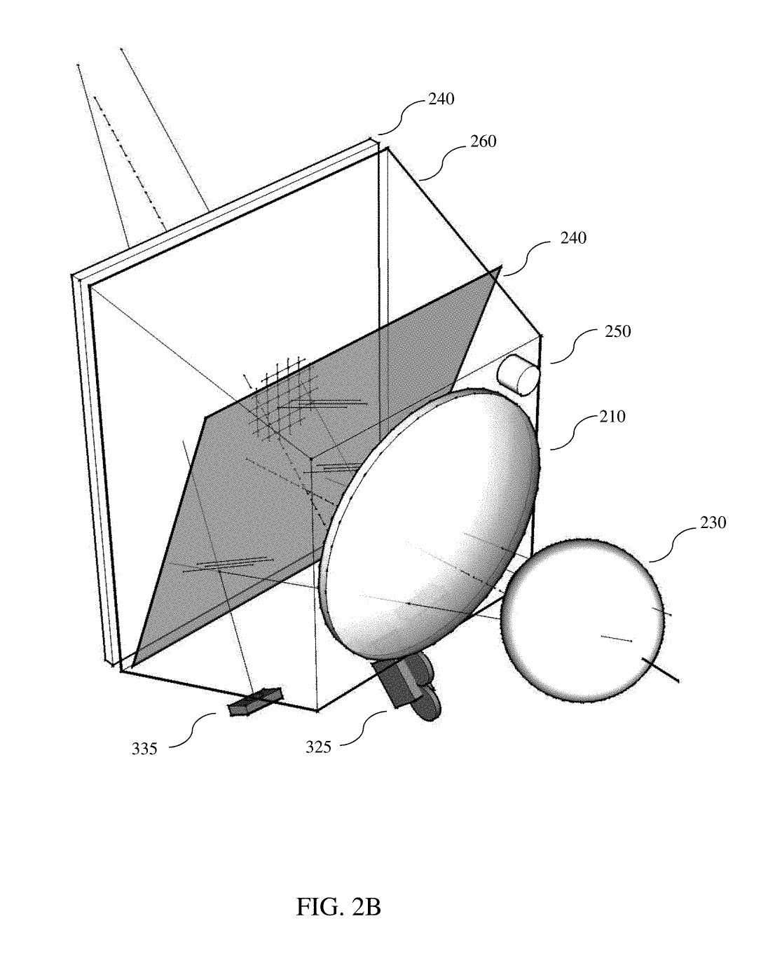

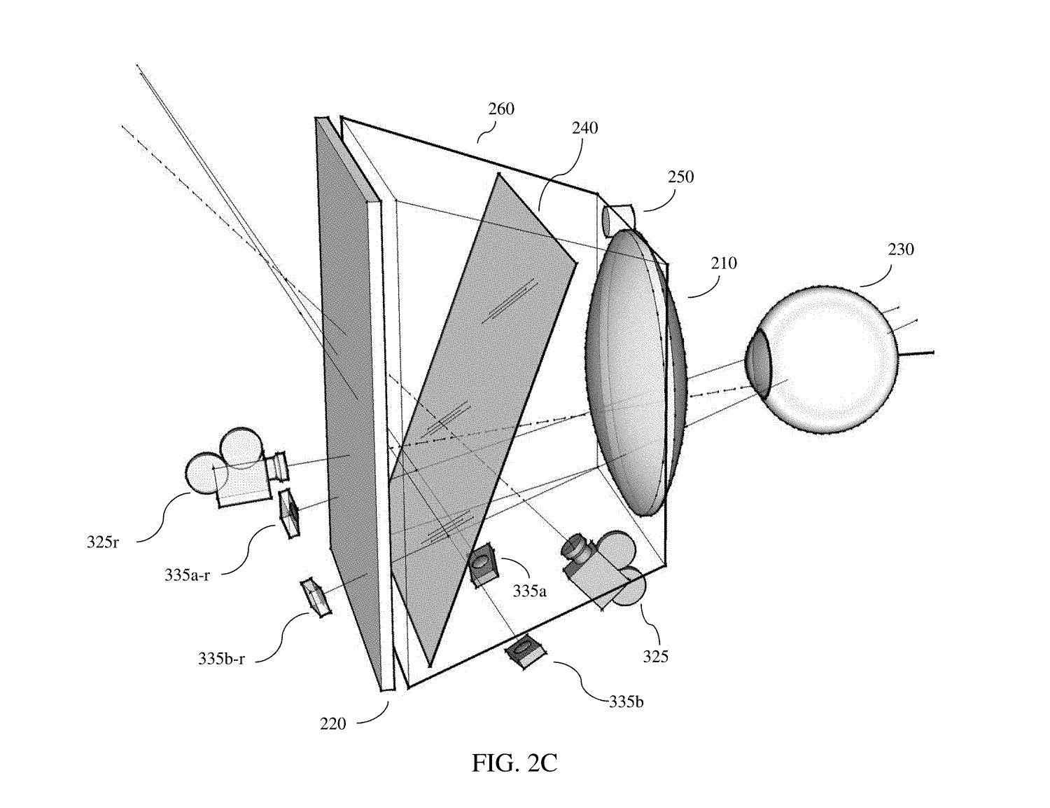

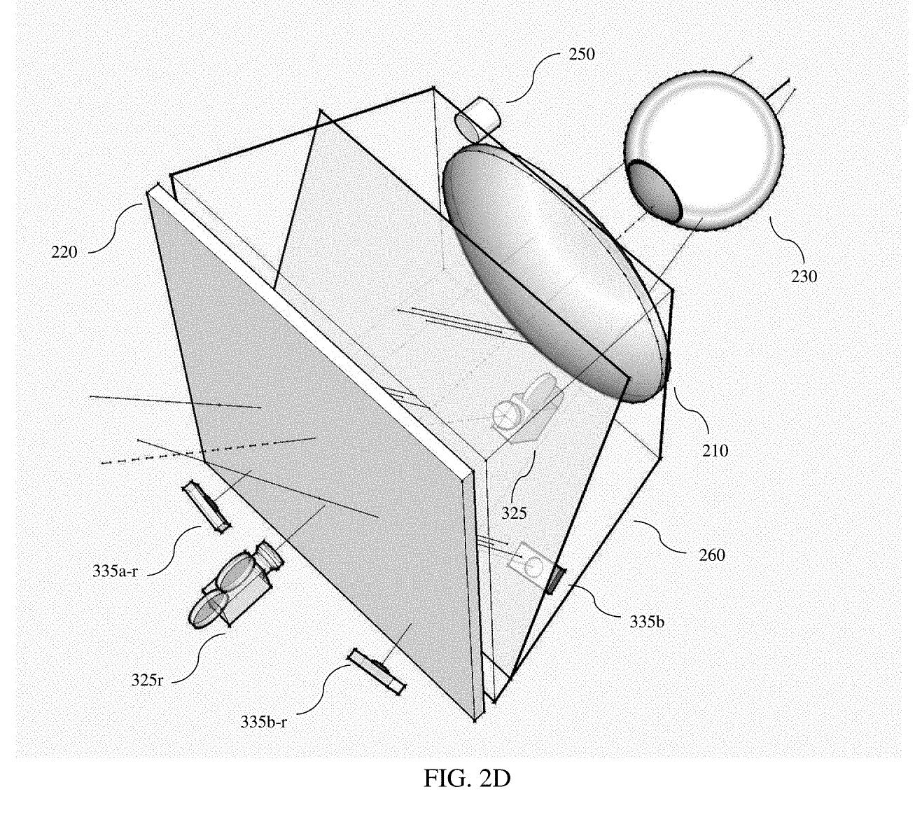

There are many possible configurations to position the positional camera-based system and optical flow sensors. FIG. 2 is an exemplary functional block diagram of an eye tracking system for HMD applications that may be used to implement aspects of certain embodiments of the present invention. As shown in FIG. 2, an exemplary implementation comprises: (1) A camera+hot mirror-based eye tracking system integrated into the HMD (for example, a commercially available global shutter infrared unit from SMI or TOBII with 200-300 pixel resolution); (2) an array of one or more multiple optical flow sensors pointed at different regions of the observation field (which may include the sclera, iris and pupil within an eye of a user), where the optical flow sensors may be implemented with commercially available devices such as Avago/Pixart ADNS-3080 high-performance optical mouse sensors with their lenses replaces with lenses that can focus on the surface of the eye under observation; (3) a sensor fusion module that integrates input from the two systems; and, optionally, (4) a noise squelching system that determines which of the optical flow sensors to ignore at any given time.

The flow sensors are aimed through a narrow field of view and wide depth of field optical element in exemplary implementations. For example, the optics may be tuned to the vascular details in the sclera. Specifically, if the area observed by a sensor is too small, there may not be enough vascular detail in view. On the other hand, if the area is too large, it may be difficult or impossible to resolve the details, and the user's eyelid may be in view too much of the time, which may impair the quality and value of detected data. In certain embodiments, optical flow sensors may be intentionally aimed at a user's eyelid, so as to assist with blink detection and with detecting when sensors aimed at the user's iris and/or sclera are observing eyelid movement, as opposed to eye rotation.

In certain embodiments, the optical flow sensors can be bounced off the same hot mirror that the image camera uses. In other embodiments, a wave guide is located in front of the lens to facilitate imaging of each of the user's eye. Since the human eye moves around quite a bit, and eyelids can interfere with optical flow during blinks or as they move with the eye, certain embodiments utilize a plurality of optical flow sensors running simultaneously, each pointing at different parts of the eye. The number of sensors depends on the particular requirement of each implementation, and is based on considerations of cost and performance.

The sensors that need to be squelched from sample to sample may be determined by the low-frequency camera-based image tracking component, since the camera image provides an overall picture of eye position, and that information can be used to cull occluded optical flow sensors Information from other optical flow sensors in the system may also be used for this squelching function. Information from the optical flow sensors can also be used to help identify blinks to help improve the validity of camera-based sample data.

FIGS. 2A-2D are exemplary diagrams depicting aspects of eye-tracking system configurations for HMD applications that may be used to implement aspects of certain embodiments of the present invention. These diagrams are intended to show general geometric configurations and spatial relationships, and are not to be construed as depictions of actual physical objects.

As shown in FIGS. 2A-2D, a user's eye 230 is under observation by the eye-tracking systems according to aspects of the present invention. Lens 210 enables the user's eye 230 to focus on the display 220. A hot mirror 240 may be disposed between the lens 210 and the display 220. The hot mirror 240 does not impede the view of the display 220 in visible light. Camera-based eye-tracking subsystems 325 and optical flow sensor subsystems 335 (which may be implemented as comprising one or more optical flow sensors) are arranged, depending on the requirements of each particular implementation, so that their reflected location observes the user's eye 230 for tracking purposes. For example, in the configuration depicted in FIG. 2A, Camera-based eye-tracking subsystem 325 is reflected at location 325r, and optical flow sensor subsystem 335 is reflected at location 335r. IR illuminator 250 generates the light source required by camera-based eye-tracking subsystem 325 and optical flow sensor subsystem 335. The IR light is generally reflected by hot mirror 240, whereas light visible by the human eye 230 is not generally reflected by hot mirror 240. Frame 260 provides mechanical support for the various components depicted, and shields the user's eye 230 from external light sources.

Thus, due to the ability of the hot mirror to reflect infrared light, the eye-tracking sensors (325, 335) detect a reflected view of the eye. FIGS. 2A-2D are exemplary, as the location of the hot mirror and the sensors can be at various locations before and behind the lens, or directed directly at the eye or indirectly through one or more mirrors, depending on the requirements of each particular implementation.

FIG. 2B depicts a three-dimensional version of the configuration shown in FIG. 2A, as seen from a perspective generally behind and to the left of a user's eye.

FIGS. 2C and 2D depict another exemplary configuration from two different angles, comprising two optical flow sensors (335a, 335b) and their respective reflected locations (335a-r, 335b-r). (Optical flow sensor 335a is not visible in FIG. 2D.)

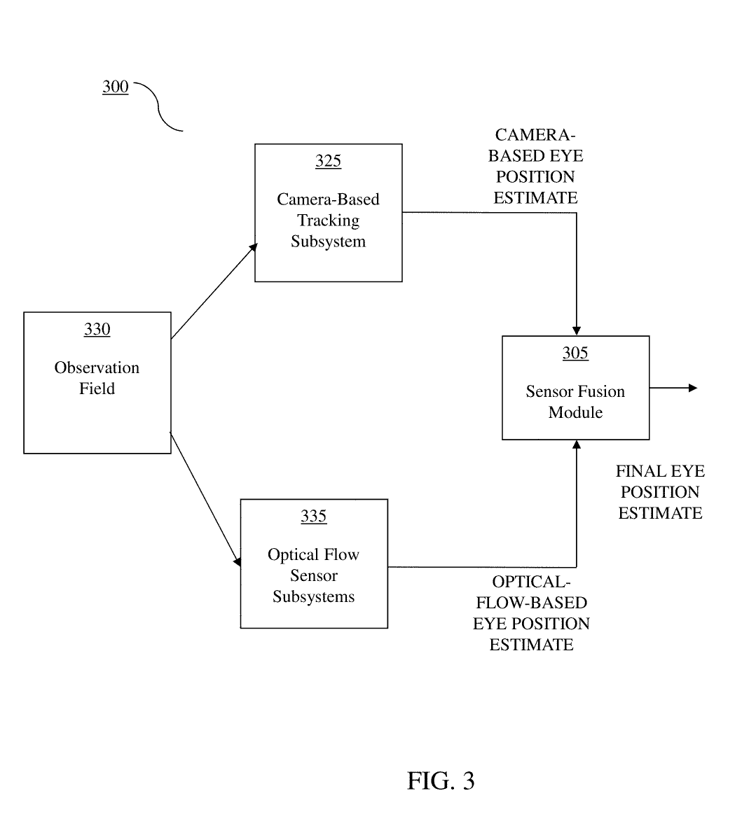

FIG. 3 is an exemplary diagram of eye-tracking system designs for HMD applications that may be used to implement aspects of certain embodiments of the present invention. FIG. 3 depicts an exemplary eye-tracking apparatus (300), comprising an eye-tracking camera subsystem (325) that captures sequential two-dimensional samples representing images of an observation field (330) at a first resolution level and at a first sample rate, where the observation field comprises a portion of a person's eye comprising a pupil, and generates a camera-based eye position estimate. FIG. 3 further depicts an array of one or more optical flow sensor subsystems (335), each pointed at a different subregion of the observation field. In certain embodiments, each of these optical flow sensors captures sequential samples representing optical flow within its corresponding subregion at a resolution level lower than the first resolution level (i.e., the resolution level of the camera-based subsystem (325)) and at a sample rate faster than the first sample rate and generates an optical-flow-based eye position estimate. For example, in certain embodiments the first resolution level is from 100 to 200 pixels in each dimension, the second resolution level is from 16 to 32 pixels in each dimension, the first sample rate is from 40 to 60 Hz, and the second sample rate is from 500 to 6400 Hz. FIG. 3 also depicts a sensor fusion module (305) that combines the camera-based eye position estimate from the eye-tracking camera subsystem (325) and the optical-flow-based eye position estimates from the array of optical flow sensors (335) to generate a final eye position estimate. In certain embodiments, the sensor fusion module utilizes a class of algorithms collectively known as Kalman filters that are useful for this class of sensor fusion problems, although several other sensor fusion techniques will be apparent to ordinarily skilled artisans.

In certain embodiments, the eye-tracking camera subsystem (325) operates in the infrared optical frequency range. In certain further embodiments, the eye-tracking apparatus 300 according to aspects of the present invention also comprises a noise squelching system that determines a subset of said one or more optical flow sensors to ignore at any given time based on the camera-based eye position estimate from the eye-tracking camera subsystem.

Depending on the particular requirements of each implementation, the eye-tracking camera subsystem and the array of optical flow sensors may be housed within a head-mounted display.

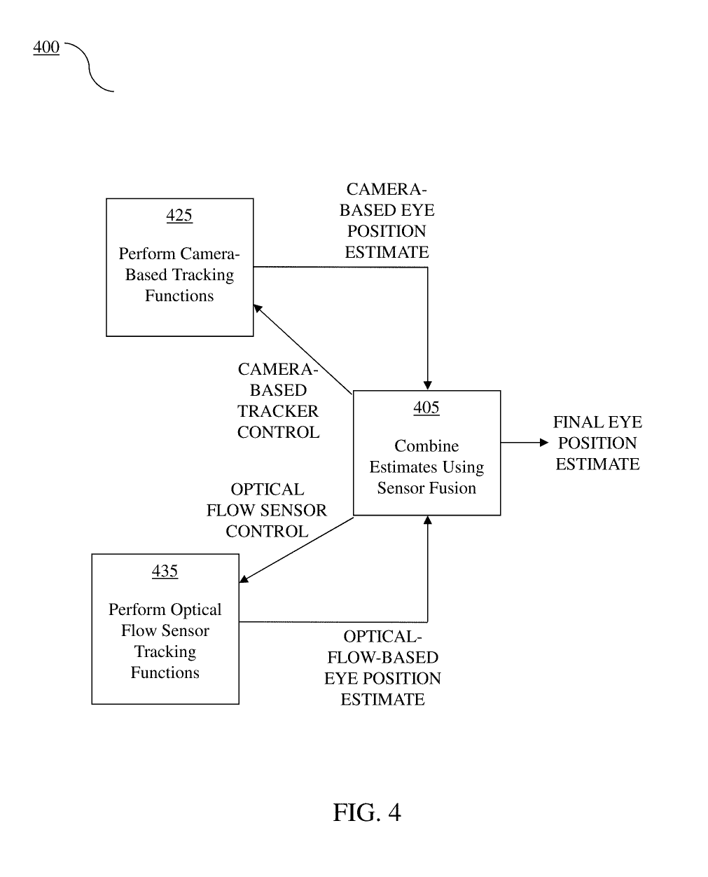

FIG. 4 is an exemplary flow diagram of eye-tracking methods for HMD applications (400) that may be used to implement aspects of certain embodiments of the present invention. As shown in FIG. 4, an exemplary method comprises capturing sequential two-dimensional samples representing images of an observation field at a first resolution level and at a first sample rate with an eye-tracking camera subsystem to generate a camera-based eye position estimate (425), where the observation field comprises a portion of a person's eye comprising a pupil. The method also comprises the step of capturing sequential samples representing optical flow within a plurality of subregions of the observation field at a resolution level lower than said first resolution level and at a sample rate faster than said first sample rate with one or more of optical flow sensors to generate a plurality of optical-flow-based eye position estimates (435). Finally, the method comprises the step of combining the camera-based eye position estimate and the optical-flow-based eye position estimates to generate a final eye position estimate using sensor fusion functions (405).

Thus, sensor fusion techniques according to aspects of the present invention enables the combination of two complementary tracking systems into a system that has the advantages of both to have high-frame-rate, low-latency, accurate eye-tracking at relatively low cost. Whereas certain existing camera-based eye-tracking systems provide regular absolute positioning information for the pupil position, they may not provide this information as often as is necessary for certain applications that could use eye-tracking. On the other hand, optical flow sensors can generate relative data at relatively high data rates, but they may provide inaccurate positional data. Sensor fusion techniques according to aspects of the present invention allows a system to combine the positional accuracy of the slow system with the relative data of the fast system to obtain the best of both worlds and provide accurate data at very low latency.

Aspects of the present invention may be implemented in certain embodiment using a field-programmable gate arrays (“FPGAs”) and microcontrollers. In such embodiments, one or more microcontrollers manage the high-speed FPGA front-end and package the data stream for delivery back to a host computer over a suitable interface bus (e.g. USB) for further processing.

In the foregoing descriptions, certain embodiments are described in terms of particular data structures, preferred and optional enforcements, preferred control flows, and examples. Other and further application of the described methods, as would be understood after review of this application by those with ordinary skill in the art, are within the scope of the invention.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or sub-combination of the elements from the different species and/or embodiments disclosed herein.

We claim:

1. An eye-tracking apparatus, comprising;
an eye-tracking camera subsystem that captures sequential two-dimensional samples representing images of an observation field at a first resolution level and at a first sample rate, wherein said observation field comprises a portion of a person's eye comprising a pupil, and generates a camera-based eye position estimate;
a plurality of optical flow sensors, each pointed at a different subregion of said observation field, wherein each of said optical flow sensors captures sequential samples representing optical flow within its corresponding subregion at a resolution level lower than said first resolution level and at a sample rate faster than said first sample rate and generates an optical-flow-based eye position estimate; and
a sensor fusion module that combines said camera-based eye position estimate from said eye-tracking camera subsystem and said optical-flow-based eye position estimates from each of said plurality of optical flow sensors to generate a final eye position estimate.

2. The eye-tracking apparatus of claim 1, wherein said eye-tracking camera subsystem operates in the infrared optical frequency range.

3. The eye-tracking apparatus of claim 1, further comprising a noise squelching system that determines a subset of said plurality optical flow sensors to ignore at any given time based on said camera-based eye position estimate from said eye-tracking camera subsystem.

4. The eye-tracking apparatus of claim 1, wherein said eye-tracking camera subsystem and said plurality of optical flow sensors are housed within a head-mounted display.

5. The eye-tracking apparatus of claim 1, wherein said sensor fusion module comprises a Kalman filter.

6. An eye-tracking method, comprising;
capturing sequential two-dimensional samples representing images of an observation field at a first resolution level and at a first sample rate with an eye-tracking camera subsystem to generate a camera-based eye position estimate, wherein said observation field comprises a portion of a person's eye comprising a pupil;
capturing sequential samples representing optical flow within a plurality of subregions of said observation field at a resolution level lower than said first resolution level and at a sample rate faster than said first sample rate with a plurality of optical flow sensors to generate a plurality of optical-flow-based eye position estimates; and
combining said camera-based eye position estimate and said optical-flow-based eye position estimates to generate a final eye position estimate using sensor fusion functions.

7. The eye-tracking method of claim 6, wherein said eye-tracking camera subsystem operates in the infrared optical frequency range.

8. The eye-tracking method of claim 6, further comprising determining a subset of said plurality optical flow sensors to ignore at any given time based on said camera-based eye position estimate from said eye-tracking camera subsystem.

9. The eye-tracking method of claim 6, wherein said eye-tracking camera subsystem and said plurality of optical flow sensors are housed within a head-mounted display.

10. The eye-tracking method of claim 6, wherein said sensor fusion functions comprise a Kalman filter.

11. An eye-tracking apparatus, comprising;
an eye-tracking camera subsystem that captures sequential two-dimensional samples representing images of an observation field at a first resolution level and at a first sample rate, wherein said observation field comprises a portion of a person's eye comprising a pupil, and generates a camera-based eye position estimate;
one or more optical flow sensors, each pointed at a different subregion of said observation field, wherein each of said optical flow sensors captures sequential samples representing optical flow within its corresponding subregion at a resolution level lower than said first resolution level and at a sample rate faster than said first sample rate and generates an optical-flow-based eye position estimate; and
a sensor fusion module that combines said camera-based eye position estimate from said eye-tracking camera subsystem and said optical-flow-based eye position estimates from each of said one or more optical flow sensors to generate a final eye position estimate.

12. The eye-tracking apparatus of claim 11, wherein said eye-tracking camera subsystem operates in the infrared optical frequency range.

13. The eye-tracking apparatus of claim 11, wherein said eye-tracking camera subsystem and said one or more optical flow sensors are housed within a head-mounted display.

14. The eye-tracking apparatus of claim 11, wherein said sensor fusion module comprises a Kalman filter.

15. An eye-tracking method, comprising;
capturing sequential two-dimensional samples representing images of an observation field at a first resolution level and at a first sample rate with an eye-tracking camera subsystem to generate a camera-based eye position estimate, wherein said observation field comprises a portion of a person's eye comprising a pupil;
capturing sequential samples representing optical flow within a one or more subregions of said observation field at a resolution level lower than said first resolution level and at a sample rate faster than said first sample rate with one or more optical flow sensors to generate a plurality of optical-flow-based eye position estimates; and
combining said camera-based eye position estimate and said optical-flow-based eye position estimates to generate a final eye position estimate using sensor fusion functions.

16. The eye-tracking method of claim 15, wherein said eye-tracking camera subsystem operates in the infrared optical frequency range.

17. The eye-tracking method of claim 15, wherein said eye-tracking camera subsystem and said plurality of optical flow sensors are housed within a head-mounted display.

18. The eye-tracking method of claim 15, wherein said sensor fusion functions comprise a Kalman filter.
